(19) United States
(12) Patent Application Publication
(10) Pub. No.: US 2017/0245200 A1
(43) Pub. Date: Aug. 24, 2017

(54) Vehicle safety system

(71) Applicants: Michael Langley, Clay Center, KS (US); Deborah P. Langley, Clay Center, KS (US)

(72) Inventors: Michael Langley, Clay Center, KS (US); Deborah P. Langley, Clay Center, KS (US)

(21) Appl. No.: 15/047,434

(22) Filed: Feb. 18, 2016

(51) Int. Cl. H04W 48/04; H04W 4/04; H04W 4/22; H04W 4/02

(52) U.S. Cl. CPC H04W 48/04; H04W 4/027; H04W 4/046; H04W 4/22

(57) ABSTRACT

A system and method for vehicle safety that automatically controls a communication device provided with a motion detection system which provides the motion of the vehicle to a micro-processing unit embedded in a communication device that disables certain functions of the communication device depending on the speed of the vehicle. The inventive system includes a sensor to detect vehicle motion and a set of instructions stored inside a non-volatile storage media coupled to processor. When a motion is detected, the system gets initiated and alters the functionality of the communication device depending upon the speed of the vehicle.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention is in the field of mobile communication devices, and, more specifically, this invention is a system and method that provides safety to commuters by limiting the functionality of their mobile communicating devices. The functionality of the communication devices explicitly depends upon the speed of the vehicle. This invention limits services and prohibits certain telecommunication functions as soon as the vehicle motion exceeds a threshold limit.

(2) Background of the Invention

Mobile phones, along with other mobile access devices, have enjoyed increasingly widespread use over the years. The capabilities of mobile access devices have also increased, allowing their users to make phone calls, send and receive text messages and emails, surf the web, view movies, listen to music, and much more.

However, as the use of these devices increases, so do the instances of distracted driving. Statistics show that, each day, over 800,000 Americans “text” (i.e., send or receive text or SMS (short message system) messages), or make phone calls while driving. Over one-third of all young drivers, ages 24 and under, text while driving. Forty-eight percent of young Americans say that they have been in a car while the driver was texting.

Nevertheless, some people use their cell phones for business, and do not want clients or customers to wonder why they did not call back right away. Other people simply want to be able to respond promptly, in some fashion, without endangering themselves or others so that the person calling them or texting them does not start to worry, since the person normally responds right away to a text or phone call.

An article in a Nov. 22, 2009 Dallas newspaper described a subscription system called ZoomSafer™ that renders driving when a cell phone is present safer. The system uses the GPS on the phone to detect when the user is driving, and then disables the cell phone until the driver stops the car. This system is believed to shut off the user's phone while the user is driving. The problem with such a system is that the user may wish to know who is calling or texting, and, if the call or text is important enough, pull over, stop the car, and answer the text or call.

Other companies, such as GM, assume that drivers' judgment can be trusted. Therefore, they have implemented hands-free OnStar™ systems that voice dial numbers that have been previously stored, and given a nametag. The user simply pushes a button and speaks the nametag to make a call. The system then automatically dials the phone number stored in the car's computer. OnStar uses a cell phone that is built into the car; this phone uses minutes purchased from OnStar. GM has also implemented Bluetooth™ systems to dial the phone owned by the user by coupling the user's cell phone to the car's audio system, and then allowing the user to dial a number from a keypad, displayed on the navigation system display of the vehicle, the cell phone, or the cell phone address book. The audio of the call is played through the car's audio system, and a microphone in the car picks up the driver's voice. Ford and Microsoft are selling systems that rely on voice commands to dial phones. The systems that disable the phones by using the phone's GPS have caught the attention of companies, because studies show that driving while talking on a cell phone is dangerous, even if the driver is using a headset, and has both hands on the wheel. One insurance company has said it will offer discounts to customers who use a call-blocking service to disable their phones.

Other companies, such as Aegis Mobility and Edge, employ systems that place restrictions on phones based upon the phone's GPS signal, data from the car itself, or nearby cell towers. Any incoming calls are routed to either voice mail, or a message explaining that the phone's user is driving. Exceptions can be made for certain numbers. The exceptions are the only control the user of the cell phone has, in these systems, to allow a call to come through.

This puts too much restriction on the driver to anticipate who might be calling, and also gives the driver no option to see the caller IDs of all incoming calls and then decide whether or not to pull over and take the call, or just take the risk of taking the call while driving.

Another prior art feature found in some phones is called “Quick Text,” and it features a menu from which the user can choose “canned” (already typed and stored in the phone) responses to send in response to a text message received. In a “Quick Text” capable phone, all the steps to reply to a text message must be done as they are normally done, but, with a few extra keystrokes, the user can choose a message that has already been typed, instead of having to type a reply message. That is, the user receives a notification that a text message (SMS) has arrived, does a keystroke or two to select the text application program, selects the text message to view, does a keystroke to put the phone into reply mode, then the user may do another keystroke to open a menu of canned messages to send as a reply. Typically, this is a keystroke to select an “Options” icon (give a command to open a menu which includes a command “Add Quick Text”). Then, another keystroke is required to select the “Add Quick Text” command. This keystroke brings up a list of canned messages that can be selected, and sent, such as “thanks”, “yes”, “no”, etc. One or more keystrokes, scrolling actions, or trackball actions are then required to select the canned message to send. After this, another keystroke is required to put the canned message into the reply screen as the message to be sent. Then, another keystroke is required to actually send the canned message just selected. This large amount of keystrokes requires the user to pay too much attention to the phone, its display, and its keypad. This amount of distraction would be unsafe while driving.

Despite the benefits of mobile devices, mobile access devices pose a hazard when used while operating a vehicle (e.g., an automobile). Therefore, it is desirable to have a means that will automatically deactivate the texting functionalities of a mobile device when in a moving automobile.

### SUMMARY OF THE INVENTION

The primary objective of the invention is to provide a system that reduces the amount of distraction faced by an operator of heavy machinery.

In one embodiment of the invention, the system can detect whether electronic devices capable of performing telecommunicating activities are active inside of heavy machinery that is also being operated, and, thereafter, selectively restrict certain applications of the electronic devices.

In a preferred embodiment, the invention is a method for limiting the functionalities of electronic devices capable of performing telecommunicating activities in defined situations or settings, or while operating heavy machinery.

In another embodiment of the invention, the method restricts the use of electronic devices capable of performing telecommunicating activities by preventing the user from accessing the SMS available to the mobile device users.

Further, in another embodiment of the invention, the method for limiting the functionality of electronic devices capable of performing telecommunicating activities includes a detection system for detecting the displacement rate of the device.

In yet another embodiment of the present invention, the method for limiting the functionality of electronic devices capable of performing telecommunicating activities includes disabling certain functionality of the electronic device in certain defined environments depending on the speed greater than the preset threshold value of the vehicle and regardless emergency numbers list.

In yet another embodiment of the present invention the functionality of a communication device is limited by preventing a user from texting while driving, or operating heavy machinery. Additionally, the method of limiting the functionality may include a detection mechanism that is capable of sensing the presence of a mobile device in a situation where a user will be operating heavy machinery, and then deactivating certain functionality, such as texting or calling, so that the operator is not distracted while operating the device.

Additionally, in one embodiment of the invention, the method can be implemented in an electronic device capable of performing telecommunicating activities in the form of a software application that may be triggered both manually and automatically.

Furthermore, according to the invention, a permanent computer would be implemented. The electronic device would have no control, or limited functionality, unless the device is operated in a hand free mode, such as operating a smart phone using voice command. Also, the device would be inoperable if it is detected in an automobile moving at a predefined speed, but would be enabled to perform emergency operations, such as calling 911.

Moreover, in another embodiment, the electronic device capable of performing telecommunicating activities is equipped with Global Positioning System service.

The summary is provided to introduce a selection of concepts, in a simplified form, that are further described below in the detailed description. This summary is not intended to identify key features, or essential features, of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description, or illustrated in the drawings. The invention is capable of other embodiments, and of being practiced and carried out in various ways. Also, it is to be understood that the phraseology and terminology employed herein are for the purpose of description, and should not be regarded as limiting. These, together with other objects of the invention, along with the various features of novelty that characterize the invention, are pointed out with particularity in the disclosure. For a better understanding of the invention, its operating advantages, and the specific objects attained by its uses, reference should be made to the accompanying drawings and descriptive matter, in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram representing the communication scheme between vehicle and mobile communication device.

FIG. 2 is a flow chart representing sequence of instructions executed during system processing.

### DETAILED DESCRIPTION OF THE INVENTION

The following is a detailed description of exemplary embodiments of the invention depicted in the accompanying drawings. The exemplary embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make such embodiments obvious to a person of ordinary skill in the art.

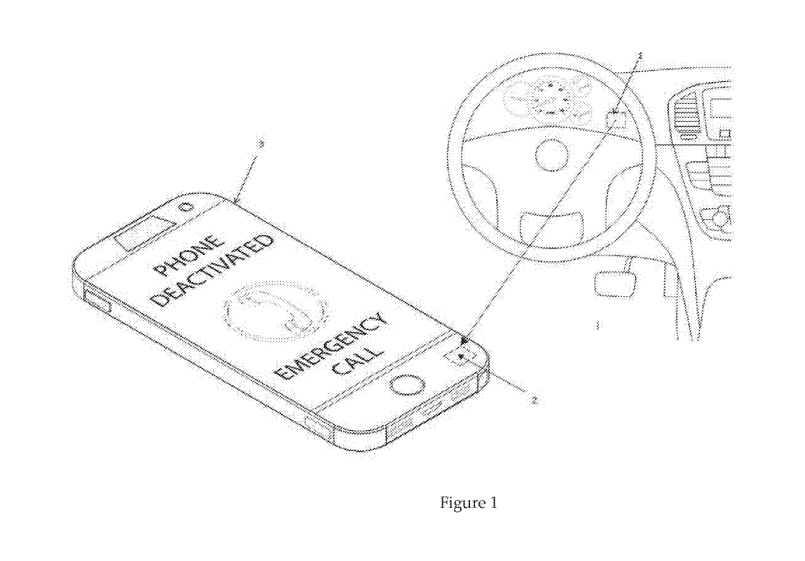

FIG. 1 representing a primary embodiment of the present invention. In this embodiment the vehicle motion can be detected using speedometer sensor (1) that is communicatively coupled to receiving sensor (2) housed in the communication device (3). The motion detection system comprises a GPS receiver or an inertial sensor embedded in the communication device (3) that is designed of detecting vehicle motion. The sensor (1) senses speed of the vehicle by detecting numbers of rotations of vehicle's shaft per unit time and transmits the same to the receiving sensor (2) of the communication device (3). This arrangement provides an instantaneous speed monitoring of the vehicle using the communication device.

According to the invention, the system would comprise of a detector that could measure the speed of vehicles, and would be a non-removable application or circuitry installed in the communication device (3) capable of controlling plurality of telecommunication functionalities such as answering a phone call, responding to a text message or dialing a phone call etc.

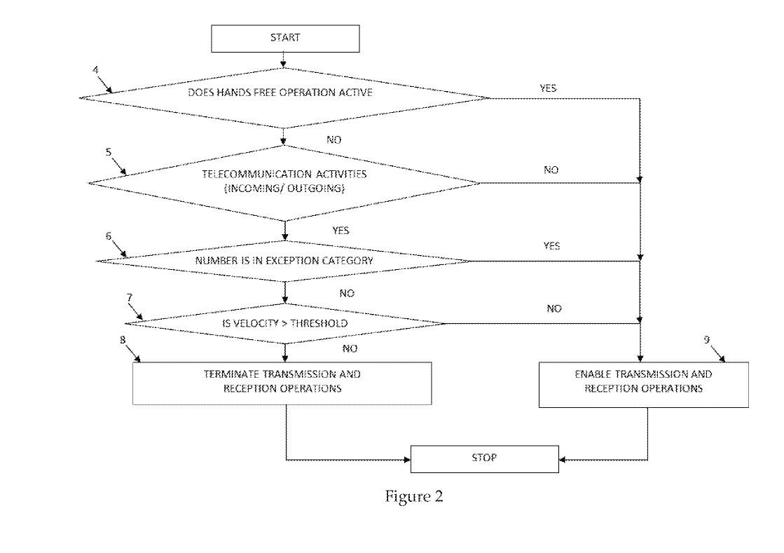

FIG. 2 referred to the sequence of steps involved in automatic motion dependent communication device control mechanism. At the first step (4) the processor checks the status of the hands free mode. The hands free operation comprises placing cellular phone in a universal mount providing a way to access the cellular phone engaged with vehicle sound system. The hands free operation executed generally using voice operated commands. However, when the communication device capable of performing telecommunication functionalities is operated in a manner that is not hands free, the system will be activated and would render the communication device capable of performing telecommunication, functionalities inoperable depending upon certain conditions like speed, emergency contact numbers etc. the device checks the status of the communication device at step (5) by analyzing the device status busy or idle. It checks whether the device is busy at incoming/outgoing call or text messages. Now the system fetches the list of emergency numbers at step (6) stored in storage media. The enlisted emergency numbers can be customized by the user and are not blocked by the communication device during a call or message or any other communication activities. List of these emergency numbers gets stored in non-volatile storage media as a list of exceptional numbers category.

In an exemplary embodiment even if the electronic device capable of performing telecommunication functions were inoperable, the device would be capable of performing emergency functions, such as calling 911.

At step (7) the velocity of the vehicle as detected by the detector is evaluated. In this process the velocity detected by sensors is compared with a predefined threshold value. The threshold value could be any safe speed limit depending on the vehicle configuration and various other parameters like driving at day time or night time etc. The threshold limit could be modified depending upon the level of safety factor a user requires. Comparison of the instantaneous speed with predefined threshold leads to a signal generation during step (8) from the processor unit that is housed in communication device resulting in deactivation of a few or all functionalities of the communication device. Now user will not get interrupted by any notifications from his/her communication device while driving at a speed more than threshold, leading to enhanced safety. User will be able to get continuous notifications and the communication device remains in active state at step (9), leading to all else conditions discussed above in the flowchart. The allowable categories comprises hands free operation (4), an activity generated from a number that belongs to emergency category (6) or the speed is low as compared to threshold (7). The process keep on executing the same sequence of steps in a loop every time communication device detects a motion coupled to vehicle in motion.

This invention can also be designed to provide a system to reduce the amount of distraction faced by an operator of heavy machinery. The system disclosed herein can detect whether one or more communication devices, such as cellular telephones, PDAs, mobile data devices, and/or laptop computers, are transmitting and/or receiving RF signals in the context of text, and whether heavy machinery, such as a vehicle, automobile, aircraft, boat, etc. is also being operated. The system can then disable, alter, or interfere with the functionality of the device while the heavy machinery is being operated. By removing these distractions, drivers may be more likely to see an oncoming vehicle that has crossed a double yellow line or a stopped car ahead to avoid hazardous accidents.

Furthermore, the connectivity of these devices can use a plurality of communication standards, protocols, and technologies, and any other suitable communication protocol, including communication protocols not yet developed as of the filing date of this document. The present invention may be implemented on applications that run on either a single, or variety, of operating system platforms or embedded operating systems.

The various hardware platforms on which the applications that implement the present invention run may use one or more processors with different instruction-sets, architectures, clock-speeds, etc. and memory may include high speed random access memory and non-volatile memory, such as one or more magnetic disk storage devices, flash memory devices, and other kinds of solid state memory devices.

Also, the electronic device capable of performing telecommunicating activities is equipped with Global Positioning System service, or receives position from another GPS.

Display means used by these hardware platforms may be LCD (liquid crystal display) technology, LED (light Emitting Diode) technology, CRT (Cathode ray tube) technology, or light emitting polymer technology, or any other display technologies.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A vehicle safety system that automatically controls a communication device comprising:
a motion detection system; wherein said motion detection system communicates the motion of the vehicle to said communication device.
a processor communicatively coupled with the motion detection system, wherein said processor is capable of controlling a plurality of functions to or from said communication device.

2. The vehicle safety system of claim 1, wherein said vehicle is selected from automobile vehicles, aircraft, boat or combination thereof.

3. The vehicle safety system of claim 1, wherein said communication device is any electronic device selected from the group of cellular phone, laptop, palmtop, PDA, computers, mobile data devices capable of receiving and transmitting RF signals or combination thereof.

4. The vehicle safety system of claim 1, wherein said motion detection system comprises a GPS receiver embedded inside the communication device.

5. The vehicle safety system of claim 1, wherein said processor is a microprocessor embedded in the communication device which controls user interface of said communication device.

6. The vehicle safety system of claim 1, wherein said plurality of functions is selected form a group of call, message reception and transmission, internet surfing, chatting, camera, listening songs, watching videos or combination thereof.

7. A method for vehicle safety that automatically controls a communication device comprising the steps of:
a) storing a preset threshold in non-volatile storage media.
b) comparing an instantaneous speed of said vehicle with said preset threshold; and
c) restricting a plurality of functionalities of communication device, as the speed surpasses said threshold.

8. The method for vehicle safety that automatically controls a communication device of claim 7, wherein said vehicle can be selected from automobile vehicles, aircraft, boat or combination thereof.

9. The method for vehicle safety that automatically controls a communication device of claim 7, wherein said communication device can be any communicating device selected from the group of cellular phone, laptop, palmtop, PDA, computers, mobile data devices capable of receiving and transmitting RF signals or combination thereof.

10. The method for vehicle safety that automatically controls a communication device of claim 7, wherein said non-volatile storage media is selected from a group of ROM, PROM, EPROM, EEPROM, MROM, flash memory, solid state storage or combination thereof.

11. The method for vehicle safety that automatically controls a communication device of claim 7, wherein said instantaneous speed is detected using a detector housed in said communication device.

12. The method for vehicle safety that automatically controls a communication device of claim 11 wherein said detector comprises of a sensor that detects instantaneous speed of said vehicle.

13. The method for vehicle safety that automatically controls a communication device of claim 12, wherein said sensor provides shaft rotational speed of said vehicle to aforesaid communication device.

14. The method for vehicle safety that automatically controls a communication device of claim 7, wherein said threshold comprises a safe speed limit.

15. The method for vehicle safety that automatically controls a communication device of claim 7, wherein said functionalities are selected from a group of call, message reception and transmission, internet surfing, chatting, camera, listening songs, watching videos or combination thereof.
